(19) United States
(12) Patent Application Publication
(10) Pub. No.: US 2006/0007078 A1
(43) Pub. Date: Jan. 12, 2006

(54) Active matrix organic light emitting diode (AMOLED) display panel and a driving circuit thereof

(75) Inventors: Kuo-Sheng Lee, Yuan Kang City (TW); Yi-Cheng Chang, Taipei (TW)

Correspondence Address: BRUCE H. TROXELL, SUITE 1404, 5205 LEESBURG PIKE, FALLS CHURCH, VA, 22041, US

(73) Assignee: AU Optronics Corp.

(21) Appl. No.: 11/033,375

(22) Filed: Jan. 12, 2005

(30) Foreign Application Priority Data
Jul. 6, 2004 (TW) 93120249

(51) Int. Cl. G09G 3/32

(52) U.S. Cl. 345/82

(57) ABSTRACT

An AMOLED display has a plurality of pixel driving units of voltage-driven design but applied with a driving current. The pixel driving unit has at least a displaying OLED and a driving transistor connected to a reference unit in parallel. The reference unit has a reference OLED and a reference transistor corresponding to the displaying OLED and the driving transistor in the pixel driving unit for defining a specific relationship between the values of the driving current passing through the pixel driving unit and a reference current passing through the reference unit.

### BACKGROUND OF THE INVENTION

(1) Field of the Invention

This invention relates to an active matrix organic light emitting diode (AMOLED) display panel and a driving circuit thereof, and more particularly to a current-driven AMOLED display panel and a driving circuit thereof.

(2) Description of the Related Art

With the progress in the fabrication technology of organic light emitting diodes (OELDs), an OLED display with a plurality of OLEDs arranged in matrix for illumination has become a popular choice among all the flat panel displays. Based on the difference in driving methods, the OLED displays in present can be sorted into simple matrix system type and active matrix system type, and the latter is a better choice for large size displays and high resolution usage.

FIG. 1 shows an equivalent circuit diagram of a pixel driving unit in a traditional voltage-driven active matrix organic light emitting diode (AMOLED) display. The pixel driving unit includes an OLED, a transistor T1, a transistor T2, and a capacitor C. A source electrode of the transistor T1 is connected to a data line (not shown in this figure) for receiving a driving voltage signal Vdata. A gate electrode of the transistor T1 is connected to a scan line (not shown in this figure) for receiving a scanning voltage signal Scan. A source electrode of the transistor T2 is connected to an anode of the OLED. A drain electrode of the transistor T2 is provided with a potential Vdd. A gate electrode of the transistor T2 is connected to a drain electrode of the transistor T1. A cathode of the OLED is provided with another potential Vss. Two opposing ends of the capacitor C are connected to the gate electrode of the transistor T2 and provided with the potential Vdd respectively.

As the scanning voltage signal Scan is at a high level state for switching on the transistor T1, the driving voltage signal Vdata on the data line is applied to the gate electrode of the transistor T2 and also the capacitor C. As the scanning voltage level Scan is at a low level state for switching off the transistor T1, the capacitor C is floated to store a potential Vcs identical to a difference between the voltage levels of Vdata and Vdd. In this situation, it is understood that the gate to source voltage Vgs of the transistor T2 equals to a difference between the voltage levels of Vdd and Vdata. A difference between the gate to source voltage Vgs and the threshold voltage Vt of the transistor T2 further determines the current I passing through the OLED for illuminating.

FIG. 2 shows an equivalent circuit diagram of a pixel driving unit in a traditional current-driven AMOLED display. As shown, the pixel driving unit includes an OLED, a transistor T1, a transistor T2, a transistor T3, a transistor T4, and a capacitor C. A source electrode of the transistor T1 is connected to a data line (not shown in this figure) for receiving a driving current signal Idata. A gate electrode of the transistor T1 is connected to a scan line (not shown in this figure) for receiving a scanning voltage signal Scan. A drain electrode of the transistor T1 is connected to a source electrode of the transistor T2. A gate electrode of the transistor T2 is connected to a gate electrode of the transistor T4. A drain electrode of the transistor T2 is connected to an anode of the OLED and also a source electrode of the transistor T4. A source electrode of the transistor T3 is connected to the data line for receiving the driving current signal Idata. A gate electrode of the transistor T3 is connected to the scan line for receiving the scanning voltage signal Scan. A drain electrode of the transistor T3 is connected to the gate electrode of the transistor T2 and also the gate electrode of the transistor T4. A source electrode of the transistor T4 is connected to the anode of the OLED. A drain electrode of the transistor T4 is provided with a potential Vdd. The cathode of the OLED is provided with another potential Vss. Two opposing ends of the capacitor C are connected to the gate electrode of the transistor T4 and the anode of the OLED respectively.

As the scanning voltage signal Scan is at a high level state for switching on the transistors T1 and T3, the driving current signal Idata is applied to the transistor T2 and the capacitor C and generates a corresponding potential Vcs stored in the capacitor C. It is noted that as the scanning voltage from the scan line is at a low level state for switching off the transistors T1 and T3, two corresponding mirror circuits with respect to the capacitor C and the OLED are created. The transistors T2 and T4 are located in the two corresponding mirror circuits respectively. As the two transistors T2 and T4 are set with identical electronic properties, the potential Vcs stored in the capacitor C may generate a current I identical to the driving current signal Idata in value passing through the transistor T4 and determine the illumination of the OLED.

In the voltage-driven pixel driving unit shown in FIG. 1, the value of the threshold voltage Vt of the transistor T2 may be significantly increased due to the accumulation of charges inside the transistor T2 during operation. Since the value of current passing through the OLED is very much influenced by the value of threshold voltage Vt in the transistor T2. A decreasing of current passing through the OLED and a worse brightness is unpreventable.

In the current-driven pixel driving unit shown in FIG. 2, the value of current passing through the OLED is determined by the driving current signal Idata and is irrelevant to the variation of the threshold voltages of the transistors T2 and T4 so as to prevent a decreasing of current passing through the OLED. However, since the current-driven pixel driving unit needs four transistors T1, T2, T3, and T4 to show the above mentioned characteristic, an increasing in fabrication cost and a worse transparency is unpreventable.

Accordingly, how to prevent the increasing of threshold voltage of the transistors in the traditional voltage-driven pixel driving unit to maintain the brightness of OLEDs, and how to reduce the number of the required electronic elements, such as transistors, in the tradition current-driven pixel driving unit to improve the transparency, are two important issues for the development of OLED display industry.

### SUMMARY OF THE INVENTION

It is a main object of the present invention to improve the transparency of the pixel driving unit in the traditional current-driven active matrix organic light emitting diode (AMOLED) display.

It is another object of the present invention to maintain a brightness of the organic light emitting diode (OLED) in the pixel driving unit of the traditional voltage-driven AMOLED display.

An AMOLED display with a plurality of pixel driving units of voltage-driven design but applied with a driving current is provided in the present invention. The pixel driving unit having at least a displaying OLED and a driving transistor is connected to a reference unit in parallel. The reference unit has a reference OLED and a reference transistor corresponding to the displaying OLED and the driving transistor in the pixel driving unit respectively for defining a specific relationship between the values of the driving current passing through the pixel driving unit and a reference current passing through the reference unit.

### BRIEF DESCRIPTION OF THE DRAWINGS

The present invention will now be specified with reference to its preferred embodiment illustrated in the drawings, in which:

FIG. 1 shows an equivalent circuit diagram of a pixel driving unit in a traditional voltage-driven AMOLED display;

FIG. 2 shows an equivalent circuit diagram of a pixel driving unit in a traditional current-driven AMOLED display;

FIG. 3 shows a block diagram depicting a preferred embodiment of the driving circuit of an AMOLED display in accordance with the present invention; and

FIG. 4 shows an equivalent circuit diagram depicting the pixel driving unit connected to the reference unit in parallel through the data line shown in FIG. 3.

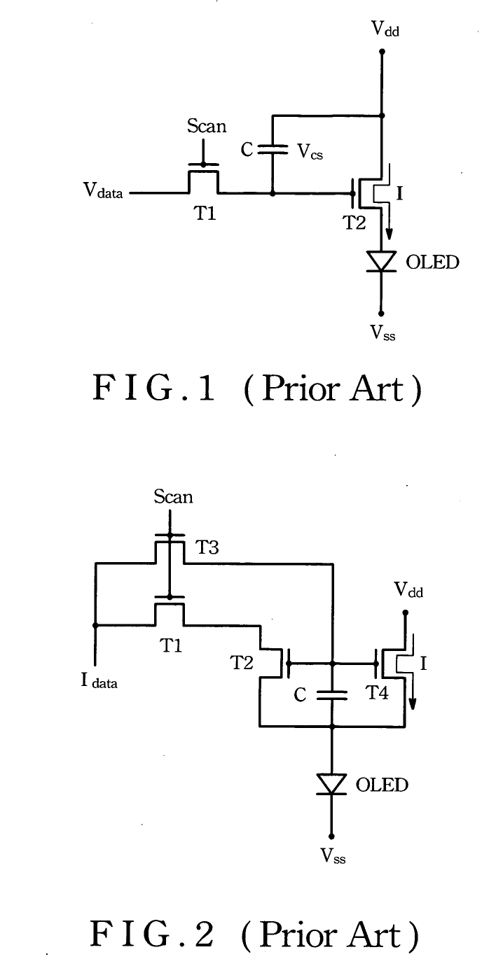

### DESCRIPTION OF THE PREFERRED EMBODIMENT

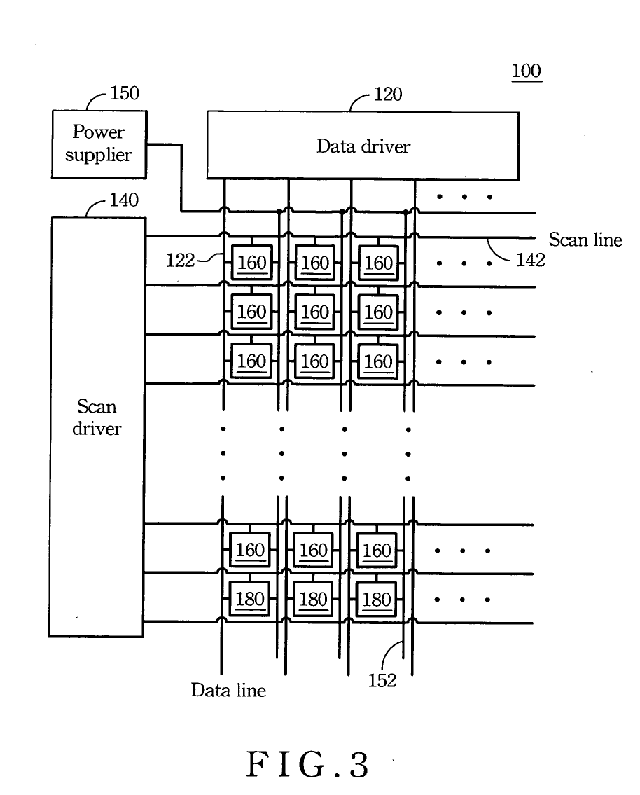

FIG. 3 shows a block diagram depicting a preferred embodiment of the driving circuit 100 of an active matrix organic light emitting diode (AMOLED) display in accordance with the present invention. The driving circuit 100 includes a data driver 120, a scan driver 140, a power supplier 150, a plurality of pixel driving units 160, and a plurality of reference units 180. The pixel driving units 160 are arranged on the display in matrix. The data driver 120 is connected to the pixel driving units 160 and the reference units 180 through a plurality of data lines 122. The scan driver 140 is connected to the pixel driving units 160 through a plurality of scan lines 142. The power supplier 150 is utilized to apply power to the organic light emitting diodes (not shown in this figure) of each pixel driving unit 160. As shown, each row of the pixel driving units 160 is coupled to a corresponded reference unit 180 through the data line 122. The reference unit 180 is arrange at the lower edge of the row of pixel driving units 160 and shielded to prevent some unwanted influence for normal displaying. By contrast with the traditional current-driven pixel driving unit of FIG. 2, the reference unit 180 is utilized to play a role as one of the mirror circuits and the required elements of the pixel driving unit 160 in the present invention can be reduced.

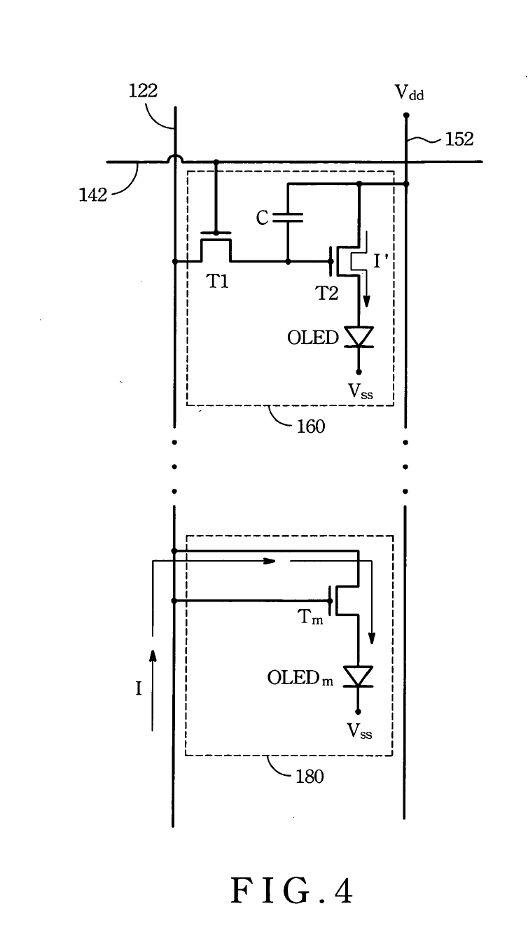

FIG. 4 shows an equivalent circuit diagram depicting the pixel driving unit 160 connected to the reference unit 180 in parallel through the data line 122 shown in FIG. 3. As shown, the pixel driving unit 160 includes a switch transistor T1, a driving transistor T2, a capacitor C, and a displaying organic light emitting diode (OLED). The switch transistor T1 has a source electrode connected to the respected data line 122 and a gate electrode connected to the respected scan line 142. The driving transistor T2 has a gate electrode connected to a drain electrode of the switch transistor T1, and has a drain electrode connected to a power supplier (not shown in this figure) through a power line 152 for receiving a first potential Vdd. The capacitor C has a first end connected to the drain electrode of the driving transistor T2 and a second end opposing to the first end connected to both the source electrode of the switch transistor T1 and the gate electrode of the driving transistor T2. The displaying OLED has an anode connected to the source electrode of the driving transistor T2 and a cathode provided with a second potential Vss, which may be corresponding to a grounded potential.

The reference unit 180 includes a reference transistor Tm corresponding to the driving transistor T2 of the pixel driving unit 160 and a reference organic light emitting diode OLEDm corresponding to the displaying organic light emitting diode OLED of the pixel driving unit 160. The reference transistor Tm has a gate electrode and a drain electrode both connected to the respected data line 122. In addition, the reference organic light emitting diode OLEDm has an anode connected to a source electrode of the reference transistor Tm and a cathode provided with the second potential Vss.

It is noted that the value of the current passing through the reference transistor Tm determines the difference between the gate to source voltage Vgs′ and the threshold voltage Vt′ of the reference transistor Tm. In addition, the voltage level of the data line Vdata equals to the sum of the gate to source voltage Vgs′, the anode to cathode voltage Voled′ of the reference organic light emitting diode OLEDm, and the second potential Vss (Vdata=Vgs′+Voled′+Vss). Therefore, a preset driving current signal I determines the voltage level Vdata on the data line.

As a scanning voltage applied through the scan line 142 to the pixel driving unit 160 is at a high level state to switch on the switch transistor T1, a voltage difference between the first potential Vdd and the voltage level on the data line 122 Vdata is applied and stored in the capacitor C. In this situation, the gate to source voltage Vgs of the driving transistor T2 equals to Vdata−Voled−Vss, wherein Voled is the anode to cathode voltage of the displaying OLED.

Since the voltage level on the data line 142 Vdata equals to Vgs′+Voled′+Vss, and the gate to source voltage Vgs of the driving transistor T2 equals to Vdata−Voled−Vss, it is calculated that the gate to source voltage Vgs of the driving transistor T2 equals to Vgs′−(Voled−Voled′). In addition, the difference between the voltage Vgs and the threshold voltage Vt of the driving transistor T2 determines the value of the current I′ passing through the displaying OLED for illumination.

As mentioned above, the driving circuit in accordance with the present invention has the following advantages.

Firstly, it is predictable that the reference organic light emitting diode OLEDm and the displaying organic light emitting diode OLED in the present invention may present similar operation time. Therefore, the increasing events of the anode to cathode voltages of the OLEDm and the OLED are similar. That is, the voltage Voled may be substantially identical to the voltage Voled′ dynamically. Since the gate to source voltage Vgs of the driving transistor T2 equals to Vgs′−(Voled−Voled′), the gate to source voltage Vgs of the driving transistor T2 is substantially identical to the gate to source voltage Vgs′ of the reference transistor Tm. The value of the gate to source voltage Vgs′ of the reference transistor Tm is determined by the driving current signal I. The value of the gate to source voltage Vgs of the driving transistor T2 determines the current I′ passing through the displaying OLED in the pixel driving unit 160 for illumination. Therefore, in the driving circuit in accordance with the present invention, a preset driving current signal I is able to determine the value of the current I′ without a bad influence of the increasing of the anode to cathode voltage of the displaying OLED.

Secondly, since the reference transistor Tm and the driving transistor T2 are predicted to have similar operating time, the threshold voltages Vt and Vt′ of the two transistor T2 and Tm may show similar increasing events. In addition, because the gate to source voltage Vgs of the driving transistor T2 is substantially identical to the gate to source voltage Vgs′ of the reference transistor Tm, the difference between the threshold voltage and the gate to source voltage of the driving transistor T2 and that of the reference transistor Tm may be substantially the same. That is, by setting the driving transistor T2 and the reference transistor Tm with identical channel width/length (W/L) ratio, the value of the current I′ passing through the displaying OLED may be substantially equal to the value of the driving current signal I and is irrelevant to the increasing of the threshold voltages Vt and Vt′ as the transistors are operating.

Thirdly, because the differences between the threshold voltage and the gate to source voltage of the driving transistor T2 and that of the reference transistor in accordance with the present invention are substantially the same, the differences of the channel W/L ratios of the reference transistor Tm and the driving transistor T2 is able to decide the relationship between the driving current signal I and the current I′ passing through the displaying OLED. For example, if the channel W/L ratio of the reference transistor Tm is two times larger than the channel W/L ratio of driving transistor T2, and the voltage Vgs equals to the voltage Vgs′, the value of the driving current signal I passing through the reference transistor Tm will be twice the value of the current I ‘passing through the driving transistor T2.

Based on this concept, it is understood that even in a low brightness condition with a small current I′ passing through the driving transistor T2, by setting a proper relationship between the channel W/L ratios of the two transistors T2 and Tm, a greater driving current signal I with respect to the current I′ can be applied on the data line 122 for charging the capacitor C of the pixel driving circuits 160 with an acceptable speed and also guarantees that the capacitor C is charged to the needed potential.

Fourthly, by contrast to the traditional current-driven pixel driving unit shown in FIG. 2, which needs four transistors for current driving utility, the pixel driving unit 160 in the present invention as shown in FIG. 3 and FIG. 4 needs only two transistors T1 and T2 for such current driving utility. Therefore, a better transparency and a greater aperture ratio is predictable.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

We claim:

1. A driving circuit for a current-driven active matrix organic light emitting diode (AMOLED) display, comprising:
a plurality of scan lines;
a plurality of data lines;
a plurality of pixel driving units, each pixel driving unit comprising:
a switch transistor having a source electrode connected to one of the data lines, and a gate electrode connected to one of the scan lines;
a driving transistor having a gate electrode connected to a drain electrode of the switch transistor, and a drain electrode provided with a first potential; and
a displaying organic light emitting diode (OLED) having an anode connected to a source electrode of the driving transistor and a cathode provided with a second potential; and
a plurality of reference units electrically connected to the pixel driving units through the data lines, each reference unit comprising:
a reference transistor, corresponding to the driving transistor, having a gate electrode, a drain electrode, and a source electrode, the gate electrode and the drain electrode being connected to the data line.

2. The driving circuit according to claim 1, wherein the channel W/L ratio of the reference transistor is substantially identical to that of the driving transistor.

3. The driving circuit according to claim 1, wherein each reference unit corresponds to one of the data lines.

4. The driving circuit according to claim 1, further comprising a power line connected to the driving transistor for applying the first potential.

5. The driving circuit according to claim 1, wherein the second potential is substantially a grounded potential.

6. The driving circuit according to claim 1, further comprising a capacitor, having an end electronically connected to both of the source electrode of the switch transistor and the gate electrode of the driving transistor.

7. The driving circuit according to claim 6, wherein the capacitor has an opposite end connected to the drain electrode of the driving transistor.

8. The driving circuit according to claim 1, wherein each of the reference units further comprises a reference OLED, corresponding to the displaying OLED, having an anode connected to the source electrode of the reference transistor, and a cathode provided with the second potential.

9. The driving circuit according to claim 1, wherein the source of the reference transistor is provided with the second potential.

10. The driving circuit according to claim 9, wherein the second potential is substantially a grounded potential.

11. A driving circuit of a current-driven active matrix organic light emitting diode (AMOLED) display, comprising:
a plurality of scan lines;
a plurality of data lines;
a plurality of pixel driving units, each pixel driving unit comprising:
a switch transistor, having a source electrode connected to one of the data lines and a gate electrode connected to one of the scan lines;
a driving transistor, having a gate electrode connected to a drain electrode of the switch transistor, and a drain electrode provided with a first potential; and
a displaying organic light emitting diode (OLED), having an anode connected to a source electrode of the driving transistor and a cathode provided with a second potential; and
a plurality of reference units, electrically connected to the pixel driving units through the data lines, each reference unit comprising:
a reference OLED, corresponding to the displaying OLED, having an anode connected to the data line, and a cathode provided with the second potential.

12. The driving circuit according to claim 11, further comprising a capacitor, having an end electronically connected to both of the source electrode of the switch transistor and the gate electrode of the driving transistor.

13. The driving circuit according to claim 12, wherein the capacitor has an opposite end connected to the drain electrode of the driving transistor.

14. The driving circuit according to claim 11, wherein the second potential is substantially a grounded potential.

15. An active matrix organic light emitting diode (AMOLED) display panel comprising:
a substrate;
a plurality of scan lines disposed on the substrate;
a plurality of data lines disposed on the substrate;
a plurality of pixel driving units disposed on the substrate, each pixel driving unit comprising:
a switch transistor, having a source electrode connected to one of the data lines and a gate electrode connected to one of the scan lines;
a driving transistor, having a gate electrode connected to a drain electrode of the switch transistor, and a drain electrode provided with a first potential; and
a displaying organic light emitting diode (OLED), having an anode connected to a source electrode of the driving transistor and a cathode provided with a second potential;
a plurality of power line connected to the driving transistor for applying the first potential; and
a plurality of reference units disposed on the substrate, electrically connected to the pixel driving units through the data lines, each reference unit comprising:
a reference transistor, corresponding to the driving transistor, having a gate electrode, a drain electrode and a source electrode, the gate electrode and the drain electrode being connected to the data line, and
a reference OLED, corresponding to the displaying OLED, having an anode connected to the source electrode of the reference transistor, and a cathode provided with the second potential.

16. The AMOLED display panel according to claim 15, wherein the pixel driving unit further comprising a capacitor, having a end electronically connected to both of the source electrode of the switch transistor and the gate electrode of the driving transistor.

17. The AMOLED display panel according to claim 16, wherein the capacitor has an opposite end connected to the drain electrode of the driving transistor.

18. The AMOLED display panel according to claim 15, wherein the second potential is substantially a grounded potential.
